(19) United States
(12) Patent Application Publication
(10) Pub. No.: US 2026/0208353 A1
(43) Pub. Date: Jul. 23, 2026

(54) MULTI-OBJECT 4D SCENE GENERATION FOR IN-THE-WILD VIDEOS

(71) Applicants: TOYOTA RESEARCH INSTITUTE, INC., Los Altos, CA (US); CARNEGIE MELLON UNIVERSITY, Pittsburgh, PA (US)

(72) Inventors: Wen-Hsuan CHU, Pittsburgh, PA (US); Lei KE, Pittsburgh, PA (US); Jianmeng LIU, Pittsburgh, PA (US); Mingxiao HUO, Pittsburgh, PA (US); Pavel TOKMAKOV, West Hollywood, CA (US); Katerina FRAGKIADAKI, Pittsburgh, PA (US)

(73) Assignees: TOYOTA RESEARCH INSTITUTE, INC., Los Altos, CA (US); TOYOTA JIDOSHA KABUSHIKI KAISHA, Aichi-Ken (JP); CARNEGIE MELLON UNIVERSITY, Pittsburgh, PA (US)

(21) Appl. No.: 19/236,292

(22) Filed: Jun. 12, 2025

Related U.S. Application Data
(60) Provisional application No. 63/748,297, filed on Jan. 22, 2025.

(51) Int. Cl. B25J 9/16; G06T 7/593; G06V 20/70

(52) U.S. Cl. CPC B25J 9/1612; B25J 9/1664; G06T 7/593; G06V 20/70

(57) ABSTRACT

A method for multi-object 4D scene generation is described. The method includes processing a monocular multi-object video to isolate each object in a 3D video scene represented by an initial video frame of the monocular multi-object video. The method also includes generating a static 3D Gaussian representation for each object in the 3D scene. The method further includes composing the 3D scene, including the static 3D Gaussian representation of each object in the 3D scene, based on initial depth predictions of each object in the 3D video scene. The method also includes jointly rendering and optimizing deformations of the static 3D Gaussian representation of each object in the 3D video scene according to a rendering loss to form a multi-object 4D scene.

### CROSS-REFERENCE TO RELATED APPLICATION

The present application claims the benefit of U.S. Provisional Patent Application No. 63/748,297, filed Jan. 22, 2025, and titled “ROBUST MULTI-OBJECT 4D GENERATION FOR IN-THE-WILD VIDEOS,” the disclosure of which is expressly incorporated by reference herein in its entirety.

### BACKGROUND

### Field

Certain aspects of the present disclosure relate to machine learning and, more particularly, multi-object 4D scene generation for in-the-wild videos.

### Background

Autonomous agents (e.g., robots, etc.) rely on machine vision for sensing a surrounding environment by analyzing areas of interest in images of the surrounding environment. Although scientists have spent decades studying the human visual system, a solution for realizing equivalent machine vision remains elusive. Realizing equivalent machine vision is a goal for enabling truly autonomous agents. Machine vision is distinct from the field of digital image processing because of the desire to recover a three-dimensional (3D) structure of the world from images and using the 3D structure for fully understanding a scene. That is, machine vision strives to provide a high-level understanding of a surrounding environment, as performed by the human visual system.

Humans effortlessly infer complete, coherent objects and their motions from video, despite perceiving only the pixels of a front “surface” of a dynamic scene that constantly move, occlude, or get occluded. Generating persistent and accurate 4D representations from monocular multi-object videos is a highly under-constrained problem, but a key to fine-grained video understanding, visual imitation for robotics, and building causal world models of intuitive physics that can simulate action consequences. A method for multi-object 4D scene generation for in-the-wild videos, is desired.

### SUMMARY

A method for multi-object 4D scene generation is described. The method includes processing a monocular multi-object video to isolate each object in a 3D video scene represented by an initial video frame of the monocular multi-object video. The method also includes generating a static 3D Gaussian representation for each object in the 3D scene. The method further includes composing the 3D scene, including the static 3D Gaussian representation of each object in the 3D scene, based on initial depth predictions of each object in the 3D video scene. The method also includes jointly rendering and optimizing deformations of the static 3D Gaussian representation of each object in the 3D video scene according to a rendering loss to form a multi-object 4D scene.

A non-transitory computer-readable medium having program code recorded thereon for multi-object 4D scene generation is described. The program code is executed by a processor. The non-transitory computer-readable medium includes program code to process a monocular multi-object video to isolate each object in a 3D video scene represented by an initial video frame of the monocular multi-object video. The non-transitory computer-readable medium also includes program code to generate a static 3D Gaussian representation for each object in the 3D scene. The non-transitory computer-readable medium further includes program code to compose the 3D scene, including the static 3D Gaussian representation of each object in the 3D scene, based on initial depth predictions of each object in the 3D video scene. The non-transitory computer-readable medium also includes program code to jointly render and optimize deformations of the static 3D Gaussian representation of each object in the 3D video scene according to a rendering loss to form a multi-object 4D scene.

A system for multi-object 4D scene generation is described. The system includes an object isolation module to process a monocular multi-object video to isolate each object in a 3D video scene represented by an initial video frame of the monocular multi-object video. The system also includes a 3D gaussian generation module to generate a static 3D Gaussian representation for each object in the 3D scene. The system further includes 3D scene composition module to compose the 3D scene, including the static 3D Gaussian representation of each object in the 3D scene, based on initial depth predictions of each object in the 3D video scene. The system also includes 4D scene generation module to jointly render and optimize deformations of the static 3D Gaussian representation of each object in the 3D video scene according to a rendering loss to form a multi-object 4D scene.

This has outlined, broadly, the features and technical advantages of the present disclosure in order that the detailed description that follows may be better understood. Additional features and advantages of the present disclosure will be described below. It should be appreciated by those skilled in the art that the present disclosure may be readily utilized as a basis for modifying or designing other structures for conducting the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a system using a system-on-a-chip (SOC) for multi-object 4D scene generation, in accordance with aspects of the present disclosure.

FIG. 2 is a block diagram illustrating a software architecture for multi-object 4D scene generation from in-the-wild videos, according to aspects of the present disclosure.

FIG. 3 is a diagram illustrating an example of a hardware implementation of a multi-object 4D scene generation system, according to various aspects of the present disclosure.

FIG. 4 is a block diagram illustrating a multi-object 4D scene generation pipeline, according to various aspects of the present disclosure.

FIG. 5 illustrates a multi-object 4D scene generation, according to various aspects of the present disclosure.

FIG. 6 is a flowchart illustrating a method for multi-object 4D scene generation, according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. Any aspect of the present disclosure disclosed may be embodied by one or more elements of a claim.

Although aspects are described herein, many variations and permutations of these aspects fall within the scope of the present disclosure. Although some benefits and advantages of the preferred aspects are mentioned, the scope of the present disclosure is not intended to be limited to benefits, uses, or objectives. Rather, aspects of the present disclosure are intended to be universally applicable to different technologies, system configurations, networks, and protocols, some of which are illustrated by way of example in the figures and in the following description of the preferred aspects. The detailed description and drawings are merely illustrative of the present disclosure, rather than limiting the scope of the present disclosure being defined by the appended claims and equivalents thereof.

Autonomous agents (e.g., robots, etc.) rely on machine vision for sensing a surrounding environment by analyzing areas of interest in images of the surrounding environment. Although scientists have spent decades studying the human visual system, a solution for realizing equivalent machine vision remains elusive. Realizing equivalent machine vision is a goal for enabling truly autonomous agents. Machine vision is distinct from the field of digital image processing because of the desire to recover a three-dimensional (3D) structure of the world from images and using the 3D structure for fully understanding a scene.

Humans effortlessly infer complete, coherent objects and their motions from video, despite perceiving only the pixels of a front “surface” of a dynamic scene that constantly move, occlude, or get occluded. Generating persistent and accurate 4D representations from monocular multi-object videos is a highly under-constrained problem, but a key to fine-grained video understanding, visual imitation for robotics, and building causal world models of intuitive physics that can simulate action consequences. As described, 4D scene generation refers to the process of creating a dynamic, multi-dimensional scene, including both spatial and temporal information.

Conventional view-predictive generative models provide powerful priors for view synthesis. Unfortunately, existing video-to-4D generation solutions based on these generative models often struggle to maintain temporal coherence and accurate 3D geometry in complex multi-object scenes due to the intricate dynamics involved, such as heavy occlusions and fast motion. Failure to incorporate both spatial and temporal information prevents 4D scenes from capturing motion and changes within a scene over a period of time to illustrate realistic movement and interactions between objects. A method for multi-object 4D scene generation for in-the-wild videos, is desired.

Various aspects of the present disclosure address the challenging problem of generating a dynamic 4D scene across views and over time from monocular videos. In some implementations, 4D scene generation is applied to in-the-wild multi-object, monocular videos with heavy occlusions. In this implementation, a proposed model decomposes the scene into object tracks and optimizes a differentiable and deformable set of 3D Gaussians for each of the object tracks. The disclosed model captures 2D occlusions from a 3D perspective by jointly splatting Gaussians of all objects to compute rendering errors in observed frames by maintaining the Gaussian grouping information. Additionally, this implementation utilizes object-centric, view-conditioned generative models for each entity to optimize score distillation objectives from unobserved viewpoints. This may be achieved by applying differentiable affine transformations to jointly optimize both global image re-projection and object-centric score distillation objectives within a unified framework. The disclosed process generates more realistic 4D multi-object scenes and produces more accurate point tracks across spatial and temporal dimensions compared to existing approaches.

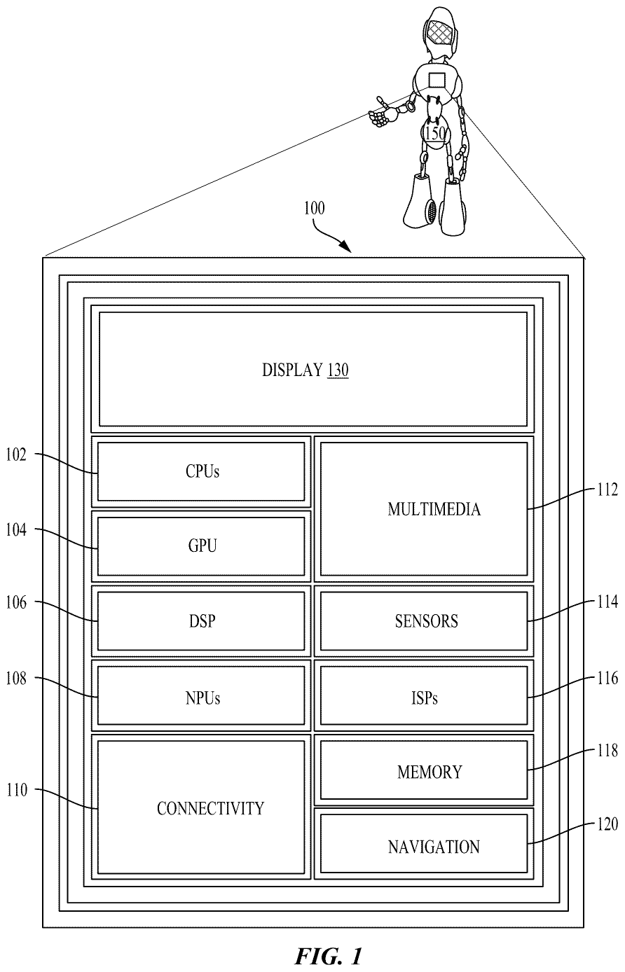

FIG. 1 illustrates an example implementation of the system and method for multi-object 4D scene generation using a system-on-a-chip (SOC) 100 of a robot 150. The SOC 100 may include a single processor or multi-core processors (e.g., a central processing unit), in accordance with certain aspects of the present disclosure. Variables (e.g., neural signals and synaptic weights), system parameters associated with a computational device (e.g., neural network with weights), delays, frequency bin information, and task information may be stored in a memory block. The memory block may be associated with a neural processing unit (NPU) 108, a CPU 102, a graphics processing unit (GPU) 104, a digital signal processor (DSP) 106, a dedicated memory block 118, or may be distributed across multiple blocks. Instructions executed at a processor (e.g., CPU 102) may be loaded from a program memory associated with the CPU 102 or may be loaded from the dedicated memory block 118.

The SOC 100 may also include additional processing blocks configured to perform specific functions, such as the GPU 104, the DSP 106, and a connectivity block 110, which may include sixth generation (6G) connectivity, sixth generation (6G) new radio (NR) connectivity, fourth generation long term evolution (4G LTE) connectivity, unlicensed Wi-Fi connectivity, USB connectivity, Bluetooth® connectivity, and the like. In addition, a multimedia processor 112 in combination with a display 130 may, for example, classify and categorize poses of objects in an area of interest, according to the display 130 illustrating a view of a robot. In some aspects, the NPU 108 may be implemented in the CPU 102, DSP 106, and/or GPU 104. The SOC 100 may further include a sensor processor 114, image signal processors (ISPs) 116, and/or navigation 120, which may, for instance, include a global positioning system.

The SOC 100 may be based on a reduced instruction set computing (RISC) machine, RISC-V, an advanced RISC machine (ARM), a microprocessor, or any reduced instruction set computing (RISC) architecture. The CPU 102 may be based on an ARM instruction set. In another aspect of the present disclosure, the SOC 100 may be a server computer in communication with the robot 150. In this arrangement, the robot 150 may include a processor and other features of the SOC 100. In this aspect of the present disclosure, instructions loaded into a processor (e.g., the CPU 102) or the NPU 108 of the robot 150 may include code for multi-object 4D scene generation for in-the-wild videos captured by the sensor processor 114. The NPU 108 of the robot 150 may include code for planning and control (e.g., of the robot 150) in response to point trajectories extracted from multi-object 4D scenes generated from in-the-wild video captured by the sensor processor 114.

The instructions loaded into a processor (e.g., the NPU 108) may also include code to process a monocular multi-object video to isolate each object in a 3D scene represented by an initial video frame of the monocular multi-object video. The instructions loaded into a processor (e.g., the NPU 108) may also include code to generate a static 3D Gaussian representation for each object in the 3D scene. The instructions loaded into a processor (e.g., the NPU 108) may further include code to compose the 3D scene, including the static 3D Gaussian representation of each object in the 3D scene, based on initial depth predictions of each object in the 3D scene. The instructions loaded into a processor (e.g., the NPU 108) may also include code to jointly render and optimize the static 3D Gaussian representation of each object in the 3D scene according to a rendering loss to form a multi-object 4D scene.

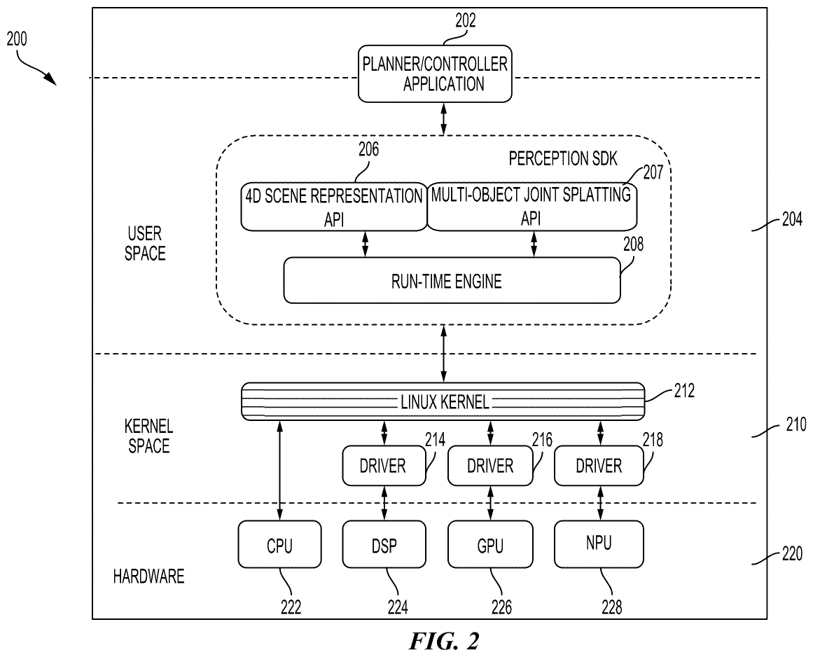

FIG. 2 is a block diagram illustrating a software architecture 200 for multi-object 4D scene generation from in-the-wild videos, according to aspects of the present disclosure. Using the software architecture 200, a planner/controller application 202 may be designed such that it may cause various processing blocks of a system-on-a-chip (SOC) 220 (for example a CPU 222, a DSP 224, a GPU 226, and/or an NPU 228) to perform supporting computations during run-time operation of the planner/controller application 202.

The planner/controller application 202 may be configured to call functions defined in a user space 204 that may, for example, utilize a generated 4D scene. Various aspects of the present disclosure address the challenging problem of generating a dynamic 4D scene across views and over time from monocular videos. In some implementations, 4D scene generation is applied to in-the-wild multi-object, monocular videos with heavy occlusions.

In various aspects of the present disclosure, the planner/controller application 202 may make a request to compile program code associated with a library defined in a 4D scene representation application programming interface (API) 206 to utilize segmentation and tracking methods to isolate each object in a scene represented by input video frames. In some implementations, score distillation sampling (SDS) is applied to generate a static 3D Gaussian of each object. The static 3D Gaussians for each object are first composed in global space with depth-based initialization. A multi-object joint splatting API 207 may optimize the static 3D Gaussians using a re-projection error from the video, along with individual object renders for score distillation. Additionally, the multi-object joint splatting API 207 performs differentiable affine transformations to jointly optimize both image-centric re-projection and object-centric score distillation objectives within a unified framework to form a multi-object 4D scene.

A run-time engine 208, which may be compiled code of a runtime framework, may be further accessible to the planner/controller application 202. The planner/controller application 202 may cause the run-time engine 208, for example, to perform object manipulation from multi-object 4D scene generation. When an object is detected within a predetermined distance of the robot, the run-time engine 208 may in turn send a signal to an operating system 210, such as a Linux Kernel 212, running on the SOC 220. The operating system 210, in turn, may cause a computation to be performed on the CPU 222, the DSP 224, the GPU 226, the NPU 228, or some combination thereof. The CPU 222 may be accessed directly by the operating system 210, and other processing blocks may be accessed through a driver, such as drivers 214, 216, 218 for the DSP 224, for the GPU 226, or for the NPU 228. In the illustrated example, the deep neural network may be configured to run on a combination of processing blocks, such as the CPU 222 and the GPU 226, or may be run on the NPU 228 if present.

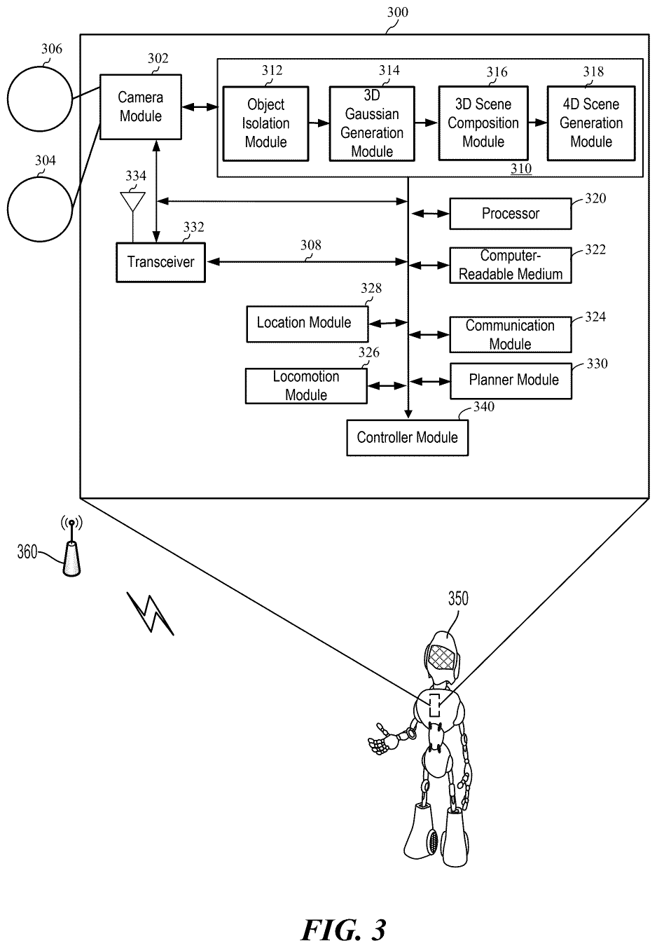

FIG. 3 is a diagram illustrating an example of a hardware implementation of a multi-object 4D scene generation system 300, according to various aspects of the present disclosure. The multi-object 4D scene generation system 300 may be configured to generate a multi-object 4D scene to enable planning and controlling of a robot in response to images from video captured through a camera during operation of a robot 350. The multi-object 4D scene generation system 300 may be a component of a robotic or other autonomous device. For example, as shown in FIG. 3, the multi-object 4D scene generation system 300 is a component of the robot 350. Aspects of the present disclosure are not limited to the multi-object 4D scene generation system 300 being a component of the robot 350, as other devices, such as an autonomous vehicle, a bus, a motorcycle, or other like autonomous vehicles, are also contemplated for using the multi-object 4D scene generation system 300. The robot 350 may be autonomous or semi-autonomous.

The multi-object 4D scene generation system 300 may be implemented with an interconnected architecture, such as a controller area network (CAN) bus, represented by an interconnect 308. The interconnect 308 may include any number of point-to-point interconnects, buses, and/or bridges depending on the specific application of the multi-object 4D scene generation system 300 and the overall design constraints of the robot 350. The interconnect 308 links together various circuits, including one or more processors and/or hardware modules, represented by a camera module 302, a perception module 310, a processor 320, a computer-readable medium 322, a communication module 324, a locomotion module 326, a location module 328, a planner module 330, and a controller module 340. The interconnect 308 may also link various other circuits such as timing sources, peripherals, voltage regulators, and power management circuits, which are well known in the art, and therefore, will not be described any further.

The multi-object 4D scene generation system 300 includes a transceiver 332 coupled to the camera module 302, the perception module 310, the processor 320, the computer-readable medium 322, the communication module 324, the locomotion module 326, the location module 328, a planner module 330, and the controller module 340. The transceiver 332 is coupled to an antenna 334. The transceiver 332 communicates with various other devices over a transmission medium. For example, the transceiver 332 may receive commands via transmissions from a user or a remote device. As discussed herein, the user may be in a location that is remote from the location of the robot 350. As another example, the transceiver 332 may transmit multi-objects represented in a 4D scene represented within a video and/or planned actions from the perception module 310 to a server (not shown).

The multi-object 4D scene generation system 300 includes the processor 320 coupled to the computer-readable medium 322. The processor 320 performs processing, including the execution of software stored on the computer-readable medium 322 to provide functionality, according to the present disclosure. The software, when executed by the processor 320, causes the multi-object 4D scene generation system 300 to perform the various functions described for robotic perception of multiple objects generated from a 4D scene represented in video captured by a camera of an autonomous agent, such as the robot 350, or any of the modules (e.g., 302, 310, 324, 326, 328, 330, and/or 340). The computer-readable medium 322 may also be used for storing data that is manipulated by the processor 320 when executing the software.

The camera module 302 may obtain images via different cameras, such as a first camera 304 and a second camera 306. The first camera 304 and the second camera 306 may be a vision sensor (e.g., a stereoscopic camera or a red-green-blue (RGB) camera) for capturing 2D RGB images. Alternatively, the camera module may be coupled to a ranging sensor, such as a light detection and ranging (LIDAR) sensor or a radio detection and ranging (RADAR) sensor. Of course, aspects of the present disclosure are not limited to the sensors, as other types of sensors (e.g., thermal, sonar, and/or lasers) are also contemplated for either of the first camera 304 or the second camera 306.

The images of the first camera 304 and/or the second camera 306 may be processed by the processor 320, the camera module 302, the perception module 310, the communication module 324, the locomotion module 326, the location module 328, and the controller module 340. In conjunction with the computer-readable medium 322, the images from the first camera 304 and/or the second camera 306 are processed to implement the functionality described herein. In one configuration, detected 2D object information captured by the first camera 304 and/or the second camera 306 may be transmitted via the transceiver 332. The first camera 304 and the second camera 306 may be coupled to the robot 350 or may be in communication with the robot 350.

Despite notable advancements, the problem of generating a dynamic 4D scene across views and over time from monocular videos remains a challenging problem. As described, 4D scene generation refers to the process of creating a dynamic, multi-dimensional scene, including both spatial and temporal information. By incorporating both spatial and temporal information, 4D scenes capture motion and changes within the scene over a period of time to illustrate realistic movement and interactions between objects.

In some implementations, the multi-object 4D scene generation system 300 is applied to in-the-wild multi-object, monocular videos with heavy occlusions to generate multi-object 4D scenes. In this implementation, the multi-object 4D scene generation system 300 decomposes a scene represented in input video frames into object tracks and optimizes a differentiable and deformable set of 3D Gaussians for each of the object tracks. The multi-object 4D scene generation system 300 captures 2D occlusions from a 3D perspective by jointly splatting Gaussians of all objects to compute rendering errors in observed frames by maintaining the Gaussian grouping information. Additionally, this implementation utilizes object-centric, view-conditioned generative models for each entity to optimize score distillation objectives from unobserved viewpoints. The multi-object 4D scene generation system 300 applies differentiable affine transformations to jointly optimize both global image re-projection and object-centric score distillation objectives within a unified framework. The multi-object 4D scene generation system 300 generates more realistic 4D multi-object scenes and produces more accurate point tracks across spatial and temporal dimensions compared to existing approaches.

The location module 328 may determine a location of the robot 350. For example, the location module 328 may use a global positioning system (GPS) to determine the location of the robot 350. The location module 328 may implement a dedicated short-range communication (DSRC)-compliant GPS unit. A DSRC-compliant GPS unit includes hardware and software to make the robot 350 and/or the location module 328 compliant with one or more of the following DSRC standards, including any derivative or fork thereof: EN 12253:2004 Dedicated Short-Range Communication—Physical layer using microwave at 5.9 GHZ (review); EN 12795:2002 Dedicated Short-Range Communication (DSRC)—DSRC Data link layer: Medium Access and Logical Link Control (review); EN 12834:2002 Dedicated Short-Range Communication—Application layer (review); EN 13372:2004 Dedicated Short-Range Communication (DSRC)—DSRC profiles for RTTT applications (review); and EN ISO 14906:2004 Electronic Fee Collection—Application interface.

A DSRC-compliant GPS unit within the location module 328 is operable to provide GPS data describing the location of the robot 350 with space-level accuracy for accurately directing the robot 350 to a desired location. For example, the robot 350 is moving to a predetermined location and desires partial sensor data. Space-level accuracy means the location of the robot 350 is described by the GPS data sufficient to confirm a location of the robot 350 parking space. That is, the location of the robot 350 is accurately determined with space-level accuracy based on the GPS data from the robot 350.

The communication module 324 may facilitate communications via the transceiver 332. For example, the communication module 324 may be configured to provide communication capabilities via different wireless protocols, such as Wi-Fi, long term evolution (LTE), 3G, etc. The communication module 324 may also communicate with other components of the robot 350 that are not modules of the 4D scene generation system 300. The transceiver 332 may be a communications channel through a network access point 360. The communications channel may include DSRC, LTE, LTE-D2D, mmWave, Wi-Fi (infrastructure mode), Wi-Fi (ad-hoc mode), visible light communication, TV white space communication, satellite communication, full-duplex wireless communications, or any other wireless communications protocol such as those mentioned herein.

In some configurations, the network access point 360 includes Bluetooth® communication networks or a cellular communications network for sending and receiving data, including via short messaging service (SMS), multimedia messaging service (MMS), hypertext transfer protocol (HTTP), direct data connection, wireless application protocol (WAP), e-mail, DSRC, full-duplex wireless communications, mmWave, Wi-Fi (infrastructure mode), Wi-Fi (ad-hoc mode), visible light communication, TV white space communication, and satellite communication. The network access point 360 may also include a mobile data network that may include 3G, 4G, 5G, 6G, LTE, LTE-V2X, LTE-D2D, VoLTE, or any other mobile data network or combination of mobile data networks. Further, the network access point 360 may include one or more IEEE 802.11 wireless networks.

The multi-object 4D scene generation system 300 also includes the planner module 330 for planning a selected trajectory to perform a route/action (e.g., collision avoidance) of the robot 350 and the controller module 340 to control the locomotion of the robot 350. The controller module 340 may perform the selected action via the locomotion module 326 for autonomous operation of the robot 350 along, for example, a selected route. In one configuration, the planner module 330 and the controller module 340 may collectively override a user input when the user input is expected (e.g., predicted) to cause a collision according to an autonomous level of the robot 350. The modules may be software modules running in the processor 320, resident/stored in the computer-readable medium 322, and/or hardware modules coupled to the processor 320, or some combination thereof.

The National Highway Traffic Safety Administration (NHTSA) has defined different “levels” of autonomous agents (e.g., Level 0, Level 1, Level 2, Level 3, Level 4, and Level 5). For example, if an autonomous agent has a higher-level number than another autonomous agent (e.g., Level 3 is a higher-level number than Levels 2 or 1), then the autonomous agent with a higher-level number offers a greater combination and quantity of autonomous features relative to the agent with the lower-level number. These distinct levels of autonomous agents are described briefly below.
Level 0: In a Level 0 agent, the set of advanced driver assistance system (ADAS) features installed in an agent provide no agent control but may issue warnings to the driver of the agent. An agent which is Level 0 is not an autonomous or semi-autonomous agent.
Level 1: In a Level 1 agent, the driver is ready to take operation control of the autonomous agent at any time. The set of ADAS features installed in the autonomous agent may provide autonomous features such as: adaptive cruise control (ACC); parking assistance with automated steering; and lane keeping assistance (LKA) type II, in any combination.
Level 2: In a Level 2 agent, the driver is obliged to detect objects and events in the roadway environment and respond if the set of ADAS features installed in the autonomous agent fail to respond properly (based on the driver's subjective judgement). The set of ADAS features installed in the autonomous agent may include accelerating, braking, and steering. In a Level 2 agent, the set of ADAS features installed in the autonomous agent can deactivate immediately upon takeover by the driver.
Level 3: In a Level 3 ADAS agent, within known, limited environments (such as freeways), the driver can safely turn their attention away from operation tasks but must still be prepared to take control of the autonomous agent when needed.
Level 4: In a Level 4 agent, the set of ADAS features installed in the autonomous agent can control the autonomous agent in all but a few environments, such as severe weather. The driver of the Level 4 agent enables the automated system (which is comprised of the set of ADAS features installed in the agent) only when it is safe to do so. When the automated Level 4 agent is enabled, driver attention is not required for the autonomous agent to operate safely and consistent within accepted norms.
Level 5: In a Level 5 agent, other than setting the destination and starting the system, no human intervention is involved. The automated system can drive to any location where it is legal to drive and make its own decision (which may vary based on the district where the agent is located).

A highly autonomous agent (HAA) is an autonomous agent that is Level 3 or higher. Accordingly, in some configurations the robot 350 is one of the following: a Level 0 non-autonomous agent; a Level 1 autonomous agent; a Level 2 autonomous agent; a Level 3 autonomous agent; a Level 4 autonomous agent; a Level 5 autonomous agent; and an HAA.

The perception module 310 may be in communication with the camera module 302, the processor 320, the computer-readable medium 322, the communication module 324, the locomotion module 326, the location module 328, the planner module 330, the transceiver 332, and the controller module 340. In one configuration, the perception module 310 receives sensor data from the camera module 302. The camera module 302 may receive RGB video image data from the first camera 304 and the second camera 306. According to aspects of the present disclosure, the perception module 310 may receive RGB video image data directly from the first camera 304 or the second camera 306 as well as an RGB depth (RGB-D) to manipulate multi-objects represented in 4D scenes generated from images captured by the first camera 304 and the second camera 306 of the robot 350. In various aspects of the present disclosure, the planner module 330 and/or the controller module 340 is configured for planning an object grasp by the robot 350 of an object represented by a 4D scene, as follows.

As shown in FIG. 3, the perception module 310 includes an object isolation module 312, a 3D Gaussian generation module 314, a 3D scene composition module 316, and a 4D scene generation module 318. The object isolation module 312, the 3D Gaussian generation module 314, the 3D scene composition module 316, and the 4D scene generation module 318 may be components of a same or different artificial neural network, such as a deep convolutional neural network (DCNN). The modules (e.g., 312, 314, 316, 318) of the perception module 310 are not limited to a CNN. In operation, the perception module 310 receives a video stream from the first camera 304 and the second camera 306. The video stream may include a 2D RGB left image from the first camera 304 and a 2D RGB right image from the second camera 306 to provide video frame images. The video stream may include multiple frames, such as image frames.

In some aspects of the present disclosure, the perception module 310 is configured to generate a multi-object 4D scene to enable planning and controlling of a robot in response to images from video captured through a camera during operation of the robot 350. The perception module 310 includes the object isolation module 312 to process a monocular multi-object video to isolate each object in a 3D scene represented by an initial video frame of the monocular multi-object video. Additionally, the perception module 310 includes the 3D Gaussian generation module 314 to generate a static 3D Gaussian representation for each object in the 3D scene. In various aspects of the present disclosure, the perception module 310 includes the 3D scene composition module 316 to compose the 3D scene, including the static 3D Gaussian representation of each object in the 3D scene, based on initial depth predictions of each object in the 3D scene. Additionally, the perception module 310 includes the 4D scene generation module 318 to jointly render and optimize the static 3D Gaussian representation of each object in the 3D scene according to a rendering loss to form a multi-object 4D scene.

### 1. Multi-Object 4D Generation

To generate dynamic 4D scenes from a monocular video with complex multi-object dynamics, a 4D generation process is introduced, which utilizes Gaussian Splatting as the 4D scene representation and leverages diffusion-based generative models for novel view synthesis.

### 1.1. Generative Gaussian Splatting

Gaussian Splatting represents a scene through a set of 3D Gaussians, each characterized by its position μ, scale s, rotation q, opacity ∝, and spherical harmonics (SH) coefficients f to represent color. To extend 3D Gaussians for novel view synthesis, score distillation sampling (SDS) is commonly applied. For example, Dream-Gaussian leverages Zero-1-to-3 as the diffusion prior, which uses a reference view and a relative camera pose to generate plausible images given a target viewpoint, lifting a single frame from 2D to 3D.

To model 3D scene dynamics, existing methods then deform these 3D Gaussians over time. Starting with a set of 3D Gaussians derived from the initial frame, each Gaussian is parameterized at each timestep by a set of learnable variables such as its 3D position μₜ, 3D rotation (a quaternion) qₜ, and 3D scale sₜ. The RGB (spherical harmonics) values and opacity remain constant across timesteps, inherited from the first-frame 3D Gaussians. Objects may be modeled dynamics by directly optimizing Gaussian deformations in an object-centric video through a K-plane based deformation network with a red-green-blue (RGB) rendering loss and an SDS loss. This approach may be extended to multi-object scenes by introducing a “decompose-recompose” strategy that optimizes 4D Gaussians for each object track independently. Unfortunately, these methods struggle with multi-object occlusions since they model objects separately, without considering the interaction and occlusions between them.

### 1.2. 4D Generation

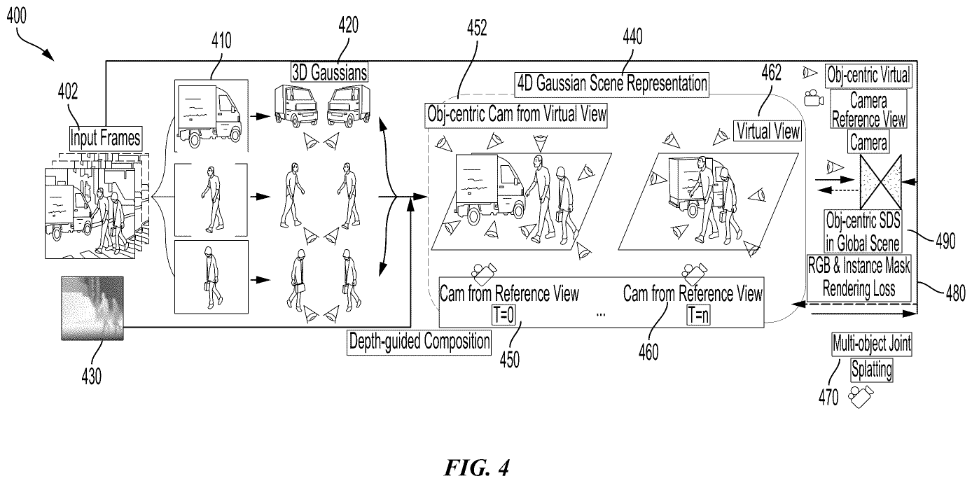

According to various aspects of the present disclosure, a 4D generation process provides a framework for video-to-4D generation in complex multi-object scenes, specifically designed to accurately model object interactions and occlusions. In some implementations, the 4D generation process employs an “early-composition” strategy by first composing 3D Gaussians in a global space with depth initialization, then optimizing for their temporal deformations. Furthermore, instance masks are rendered to preserve Gaussian instance identities during the joint splatting process, effectively managing significant 2D mutual occlusions between objects by leveraging the compositional structure of the 3D scene, for example, as shown in FIG. 4.

FIG. 4 is a block diagram illustrating a multi-object 4D scene generation pipeline, according to various aspects of the present disclosure. As shown in FIG. 4, operation of the multi-object 4D scene generation pipeline 400 begins with a monocular video of input video frames 402. In this example, the multi-object 4D scene generation pipeline 400 utilizes segmentation and tracking methods to isolate each object 410 in a scene represented by the input video frames 402. In some implementations, score distillation sampling (SDS) is applied to generate a static 3D Gaussian 420 of each object 410. The static 3D Gaussians 420 for each object 410 are first composed in global space with depth-based initialization using a pre-trained video depth estimator 430.

According to various aspects of the present disclosure, the multi-object 4D scene generation pipeline 400 includes a 4D Gaussian scene representation stage 440, in which the static 3D Gaussians 420 are optimized using re-projection error from the video, along with individual object renders for score distillation. For example, an initial camera reference view 450 provides an object-centric camera from a virtual view 452 to a final camera reference view 460 providing a mutual view 462. Additionally, the multi-object 4D scene generation pipeline 400 includes a multi-object joint splatting stage 470, in which differentiable affine transformations are employed to jointly optimize both image-centric re-projection and object-centric score distillation objectives within a unified framework of the multi-object 4D scene generation pipeline 400.

In various aspects of the present disclosure, the multi-object joint splatting stage 470 implements a differentiable affine warping scheme to transform the static 3D Gaussians 420 between a world coordinate frame and an object-centric frame. This transformation enables a unified application of both object-centric score distillation sampling (SDS) and global rendering losses. In some implementations, mask tracks are used for each object to extract bounding box tracks (BBoxₜ) of the object for each frame t. This implementation subsequently solves for 2D affine warps {Wₜ} that transform the BBoxₜ to bounding boxes corresponding to a desired object-centric bounding box.

As shown in FIG. 4, each warp geometrically corresponds to a translation to reposition the object to an object-centered location and scaling to resize it to the desired dimensions. Wₜ is then unprojected to 3D using the camera's projection matrix, which can be applied to the Gaussians of each object 410 to transform and render the Gaussians of each object 410 in an object-centric frame. Accordingly, various aspects of the present disclosure jointly optimize the 3D Gaussians of each object 410 with the SDS loss in the object-centric frame and also apply rendering losses in the original video frames It under the reference camera.

As illustrated in FIG. 4, a disclosed 4D generation method processes a monocular multi-object video of the of input video frames 402 by first isolating each object 410 using state-of-the-art segmenters and trackers. Additionally, score distillation sampling (SDS) is subsequently applied with diffusion priors to generate the static 3D Gaussian 420 for each object 410. Unlike conventional solutions, which independently optimizes Gaussian deformations and later composes the objects, the disclosed 4D generation composes the entire 3D scene upfront using initial depth predictions. This enables a joint optimization of all Gaussian deformations, enhancing stability and overall generation quality utilizing object-centric virtual cameras as well as reference view cameras.

### 1.2.1. Multi-Object Joint Splatting

As shown in FIG. 4, after independently optimizing the 3D Gaussians 420 for each object 410 in the initial, input video frames 402, the 3D Gaussians 420 for each object 410 are composed within a unified coordinate frame to create a coherent 3D scene with initial depth ordering. In this example, the coherent 3D scene with initial depth ordering is shown using a camera from the virtual view 452 of the initial camera reference view 450 at time T=0 of the 4D Gaussian scene representation stage 440. This process involves determining the depth and scaling of each object 410 along the camera rays of the camera from the virtual view 452. Specifically, the pre-trained video depth estimator 430 is employed to determine the relative depth of each object 410, which then guides the composition of the 4D Gaussian scene representation stage 440. For example, a “reference” object j is randomly selected, and a relative depth scaling is computed for every other object i as

$${k}_{i} = \frac{{D}_{i}}{{D}_{j}}$$

in each frame, where Dᵢ and Dⱼ are the median depth for objects i and j.

At the t-th, frame, the original 3D position

$${μ}_{t}^{i}$$

and scale

$${s}_{t}^{i}$$

of the Gaussians for object i are scaled along the camera rays using the scaling factor

$${p}_{t}^{i} = {C}^{r} - ( {C}^{r} - {μ}_{t}^{i} ) \times {k}_{i} and {s}_{t}^{i} = {s}_{t}^{i} \times {k}_{i} ,$$

where p is the updated 3D position and C^{r} denotes the camera position.

With these multi-object 3D scenes composed at each timestep T (e.g., T=0, . . . , T=n), the static 3D Gaussians 420 from each object 410 are jointly rendered and optimized using an RGB rendering loss [symbol] and a flow rendering loss [symbol] (e.g., an RGB and instance mask rendering loss 480. This process enables formation of the mutual view 462 at the final camera reference view 460.

### 1.2.2. Instance and Occlusion-Aware Gaussian Splatting

Jointly optimizing deformations can introduce a failure mode where the static 3D Gaussians 420 from different ones of each object 410 “jump” to one another during close interactions or occlusions. To mitigate this issue, various aspects of the present disclosure assign a one-hot encoding instance label as an additional Gaussian attribute to each static 3D Gaussian 420 and incorporate an instance mask rendering loss.

Various aspects of the present disclosure configure a differentiable 3D Gaussian renderer to render these one-hot encoding instance labels, for providing an instance segmentation map for each frame. Once computed, the rendered instance segmentation map ŷₖ is then compared against the masks obtained from the pre-trained object mask tracker yₖ (Section 1.2) using a standard negative log-likelihood loss

$${ℒ}_{c l a s s} = - {\sum }_{k} {y}_{k} log {\hat{y}}_{k} .$$

During optimization, the one-hot class label attributes of the Gaussians remain fixed, so any adjustments to the rendered instance segmentation map ŷk can only result from Gaussian movements in the 3D space. Accurate modeling of complex multi-object occlusions is possible because the static 3D Gaussians 420 do not undergo identity switches (e.g., “jump” to another object).

### 1.2.3. Scene Modeling for In-the-Wild Videos

Long videos captured in natural environments often exhibit shadow and illumination changes as objects move, leading to variations in observed RGB values. To model this behavior, various aspects of the present disclosure utilize 3D scene reconstruction with unconstrained multi-view image sets and do not maintain Gaussian colors fixed across time. This implementation allows Gaussian colors to smoothly change over time by introducing an additional multilayer perceptron (MLP) head on top of a deformation K-plane to predict time-dependent adjustments to spherical harmonic coefficients in response to these observed color changes. The K-plane provides an inductive bias where Gaussians nearby in space and time should have similar color changes. An additional L1 regularization term [symbol] is introduced to prevent the Gaussians from abusing this relaxation to explain all visual changes in the video.

### 1.2.4. Object-Centric SDS Optimization in Global Scene

In monocular videos (e.g., the input video frames 402), unobserved views of the scene lack constraints, so various aspects of the present disclosure rely on view-conditioned generative models for regularization. Unfortunately, these view-conditioned generative models work best in object-centric settings, while the disclosed 4D generation directly represents all objects within a global coordinate frame. To bridge this gap, various aspects of the present disclosure design a differentiable affine warping scheme to transform object Gaussians between the world coordinate frame and object-centric frames 490, enabling a unified application of both object-centric SDS and global rendering losses during the multi-object joint splatting stage 470.

Specifically, some implementations utilize the mask tracks for each object from Section 1.2 to extract bounding box tracks BBoxₜ of the object for each frame t. This implementation solves for 2D affine warps {Wₜ} that transform BBoxₜ to bounding boxes corresponding to the desired object-centric bounding box. Geometrically, each warp corresponds to a translation to reposition the object to an object-centered location and scaling to resize it to the desired dimensions. Wₜ can then be un-projected to 3D using the camera's project matrix, which can be applied to the static 3D Gaussians 420 of each object 410 to transform and render the static 3D Gaussians 420 in an object-centric frame (e.g., the mutual view 462). This implementation jointly optimizes the static 3D Gaussians 420 of each object 410 with the SDS loss in the object-centric frames 490 and also apply rendering losses (e.g., a red-green-blue (RGB) rendering and instance mask rendering loss 480) in the original video frames It under the reference camera pose during the multi-object joint splatting stage 470.

### 1.2.5. Optimization Objective

A disclosed optimization objective is described by a combination of [symbol] and [symbol] (Section 1.2.1), the SDS loss, [symbol] (Section 1.2.2), and [symbol] (Section 1.2.3). Additionally, a local rigidity loss is included as a further as a further regularization term to part of the multi-object joint splatting stage 470.

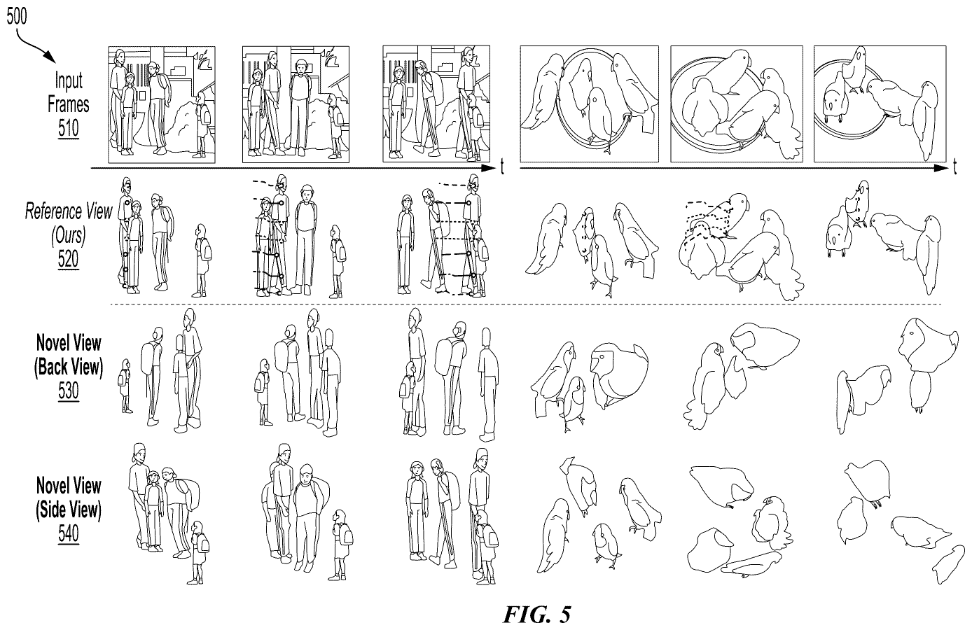

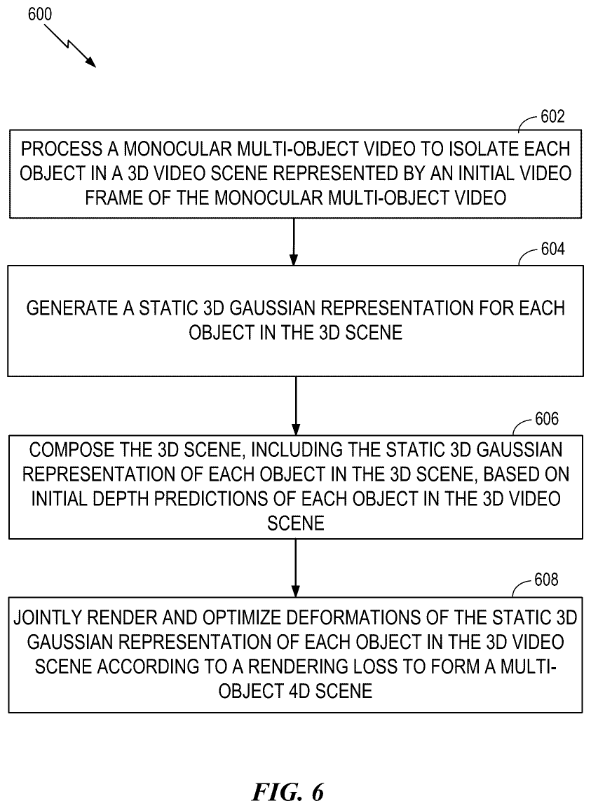

FIG. 5 illustrates a multi-object 4D scene generation 500, according to various aspects of the present disclosure. As shown in FIG. 5, the multi-object 4D scene generation 500 extends video-to-4D generation to complex, real-world scenarios characterized by heavy multi-object occlusions and rapid motion from input frames 510. In this example, the multi-object 4D scene generation 500 creates a complete 4D scene representation with 360° novel view synthesis and accurate point motion tracking in a reference view 520. In particular, the multi-object 4D scene generation 500 includes rendered images from diverse viewpoints and motion trajectories (visualizing a single object for clarity) in there-rendered images across different time steps, including a first novel view 530 (e.g., back view) and a second novel view 540 (e.g., side view). A process for multi-object 4D scene generation from in-the-wild video is further illustrated in FIG. 6.

FIG. 6 is a flowchart illustrating a method for multi-object 4D scene generation, according to aspects of the present disclosure. The method 600 begins at block 602, in which a monocular multi-object video is processed to isolate each object in a 3D video scene represented by an initial video frame of the monocular multi-object video. For example, as shown in FIG. 4, operation of the multi-object 4D scene generation pipeline 400 begins with a monocular video of input video frames 402. In this example, the multi-object 4D scene generation pipeline 400 utilizes segmentation and tracking methods to isolate each object 410 in a scene represented by the input video frames 402.

At block 604, a static 3D Gaussian representation is generated for each object in the 3D scene. For example, as shown in FIG. 4, the multi-object 4D scene generation pipeline 400 utilizes segmentation and tracking methods to isolate each object 410 in a scene represented by the input video frames 402. In some implementations, score distillation sampling (SDS) is applied to generate a static 3D Gaussian 420 of each object 410. The static 3D Gaussians 420 for each object 410 are first composed in global space with depth-based initialization using a pre-trained video depth estimator 430.

At block 606, the 3D scene is composed to including the static 3D Gaussian representation of each object in the 3D scene, based on initial depth predictions of each object in the 3D video scene. For example, as in FIG. 4, after independently optimizing the 3D Gaussians 420 for each object 410 in the initial, input video frames 402, the 3D Gaussians 420 for each object 410 are composed within a unified coordinate frame to create a coherent 3D scene with initial depth ordering. In this example, the coherent 3D scene with initial depth ordering is shown using a camera from the virtual view 452 of the initial camera reference view 450 at time T=0 of the 4D Gaussian scene representation stage 440. This process involves determining the depth and scaling of each object 410 along the camera rays of the camera from the virtual view 452. Specifically, the pre-trained video depth estimator 430 is employed to determine the relative depth of each object 410, which then guides the composition of the 4D Gaussian scene representation stage 440.

At block 608, deformations of the static 3D Gaussian representation of each object in the 3D video scene are jointly rendered and optimized according to a rendering loss to form a multi-object 4D scene. For example, as in FIG. 4, with the multi-object 3D scenes composed at each timestep T (e.g., T=0, . . . , T=n), the static 3D Gaussians 420 from each object 410 are jointly rendered and optimized using an RGB rendering loss [symbol] and a flow rendering loss [symbol] (e.g., an RGB and instance mask rendering loss 480. This process enables formation of the mutual view 462 at the final camera reference view 460. Jointly optimizing deformations can introduce a failure mode where the static 3D Gaussians 420 from different ones of each object 410 “jump” to one another during close interactions or occlusions. To mitigate this issue, various aspects of the present disclosure assign a one-hot encoding instance label as an additional Gaussian attribute to each static 3D Gaussian 420 and incorporate an instance mask rendering loss.

In some aspects of the present disclosure, the method 600 may be performed by the SOC 100 (FIG. 1) or the software architecture 200 (FIG. 2) of the robot 150 (FIG. 1). That is, each of the elements of method 600 may, for example, but without limitation, be performed by the SOC 100, the software architecture 200, or the processor (e.g., CPU 102) and/or other components included therein of the robot 150.

Various aspects of the present disclosure provide a differentiable affine warping scheme to transform object Gaussians between a world coordinate frame and an object-centric frame. This transformation enables a unified application of both object-centric score distillation sampling (SDS) and global rendering losses. In some implementations, mask tracks are used for each object to extract bounding box tracks (BBoxₜ) of the object for each frame t. This implementation subsequently solves for 2D affine warps {Wₜ} that transforms the BBoxₜ to bounding boxes corresponding to a desired object-centric bounding box. Geometrically, each warp corresponds to a translation to reposition the object to an object-centered location and scaling to resize it to the desired dimensions. Wₜ is then unprojected to 3D using the camera's projection matrix, which can be applied to each object's Gaussians to transform and render the objects Gaussians in an object-centric frame. Accordingly, various aspects of the present disclosure jointly optimize each object's 3D Gaussians with the SDS loss in the object-centric frame and also apply rendering losses in the original video frames It under the reference camera.

The various operations of methods described above may be performed by any suitable means capable of performing the corresponding functions. The means may include various hardware and/or software component(s) and/or module(s), including, but not limited to, a circuit, an application-specific integrated circuit (ASIC), or processor. Where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Additionally, “determining” may include receiving (e.g., receiving information), accessing (e.g., accessing data in a memory), and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules, and circuits described in connection with the present disclosure may be implemented or performed with a processor configured according to the present disclosure, a digital signal processor (DSP), an ASIC, a field-programmable gate array signal (FPGA) or other programmable logic device (PLD), discrete gate or transistor logic, discrete hardware components, or any combination thereof designed to perform the functions described herein. The processor may be a microprocessor, but in the alternative, the processor may be any commercially available processor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media may include random access memory (RAM), read-only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may connect a network adapter, among other things, to the processing system via the bus. The network adapter may implement signal processing functions. For certain aspects, a user interface (e.g., keypad, display, mouse, joystick, etc.) may also be connected to the bus. The bus may also link various other circuits, such as timing sources, peripherals, voltage regulators, power management circuits, and the like, which are well known in the art, and therefore, will not be described any further.

The processor may be responsible for managing the bus and processing, including the execution of software stored on the machine-readable media. Examples of processors that may be specially configured according to the present disclosure include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read-only memory (ROM), programmable read-only memory (PROM), erasable programmable read-only memory (EPROM), electrically erasable programmable read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such with cache and/or specialized register files. Although the various components discussed may be described as having a specific location, such as a local component, they may also be configured in numerous ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic or graphics processors for implementing the neuron models and models of neural systems described herein. As another alternative, the processing system may be implemented with an ASIC with the processor, the bus interface, the user interface, supporting circuitry, and at least a portion of the machine-readable media integrated into a single chip, or with one or more PGAs, PLDs, controllers, state machines, gated logic, discrete hardware components, or any other suitable circuitry, or any combination of circuits that can perform the various functions described throughout the present disclosure. Those skilled in the art will recognize how best to implement the described functionality for the processing system depending on the application and the overall design constraints imposed on the overall system.

The machine-readable media may comprise several software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media, including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc; where disks usually reproduce data magnetically, while discs reproduce data optically with lasers. Thus, in some aspects computer-readable media may comprise non-transitory computer-readable media (e.g., tangible media). In addition, for other aspects, computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for multi-object 4D scene generation, the method comprising:
processing a monocular multi-object video to isolate each object in a 3D video scene represented by an initial video frame of the monocular multi-object video;
generating a static 3D Gaussian representation for each object in the 3D scene;
composing the 3D scene, including the static 3D Gaussian representation of each object in the 3D scene, based on initial depth predictions of each object in the 3D video scene; and
jointly rendering and optimizing deformations of the static 3D Gaussian representation of each object in the 3D video scene according to a rendering loss to form a multi-object 4D scene.

2. The method of claim 1, further comprising employing differentiable affine transformations to jointly optimize both image-centric re-projection and object-centric score distillation objectives within a unified framework.

3. The method of claim 1, in which processing further comprises:
segmenting the video frame to identify each of the objects in the 3D video scene represented by the initial video frame; and
tracking each of the objects in the 3D scene represented by the initial video frame in subsequent one of the video frames of the monocular multi-object video.

4. The method of claim 1, in which composing comprises:
determining a video depth and scaling of each of the objects in the 3D video scene along camera rays; and
composing the 3D scene at each timestep of the monocular multi-object video.

5. The method of claim 1, in which the rendering loss comprises a red-green-blue (RGB) rendering loss and a flow rendering loss.

6. The method of claim 1, further comprising:
assigning a one-hot encoding instance label to each of the static 3D Gaussian representations of each object in the 3D video scene; and
rendering each of the one-hot encoding instance labels to provide an instance segmentation map for each of the video frames of the multi-object video.

7. The method of claim 6, further comprising:
comparing the instance segmentation map against masks obtained from a pre-trained object mask tracker using a negative log-likelihood loss; and
modeling multi-object occlusions according to the negative log-likelihood loss.

8. The method of claim 1, further comprising planning an object grasp by a robot of an object represented by the completed 3D shape.

9. The method of claim 1, further comprising:
applying score distillation sampling (SDS) to each object identified in the initial video frame to form the static 3D gaussian representations of each object identified in the initial video frame;
composing the static 3D Gaussians for each object in a global space using depth-based initialization and optimization; and
re-projecting error from an input video, along with individual object renders for score distillation.

10. The method of claim 1, further comprising:
decomposing the 3D video scene into object tracks;
optimizing a differentiable and deformable set of the static 3D Gaussians for each of the object tracks;
jointly splatting the static 3D Gaussians for each of the object tracks to compute rendering errors in observed frames; and
applying differentiable affine transformations to jointly optimize both global image re-projection and object-centric score distillation objectives within a unified framework.

11. A non-transitory computer-readable medium having program code recorded thereon for multi-object 4D scene generation, the program code being executed by a processor and comprising:
program code to process a monocular multi-object video to isolate each object in a 3D video scene represented by an initial video frame of the monocular multi-object video;
program code to generate a static 3D Gaussian representation for each object in the 3D scene;
program code to compose the 3D scene, including the static 3D Gaussian representation of each object in the 3D scene, based on initial depth predictions of each object in the 3D video scene; and
program code to jointly render and optimize deformations of the static 3D Gaussian representation of each object in the 3D video scene according to a rendering loss to form a multi-object 4D scene.

12. The non-transitory computer-readable medium of claim 11, further comprising:
program code to employ differentiable affine transformations to jointly optimize both image-centric re-projection and object-centric score distillation objectives within a unified framework;
program code to segment the video frame to identify each of the objects in the 3D video scene represented by the initial video frame; and
program code to track each of the objects in the 3D scene represented by the initial video frame in subsequent one of the video frames of the monocular multi-object video.

13. The non-transitory computer-readable medium of claim 11, in which composing comprises:
program code to determine a video depth and scaling of each of the objects in the 3D video scene along camera rays; and
program code to compose the 3D scene at each timestep of the monocular multi-object video.

14. The non-transitory computer-readable medium of claim 11, further comprising:
program code to assign a one-hot encoding instance label to each of the static 3D Gaussian representations of each object in the 3D video scene;
program code to render each of the one-hot encoding instance labels to provide an instance segmentation map for each of the video frames of the multi-object video;
program code to compare the instance segmentation map against masks obtained from a pre-trained object mask tracker using a negative log-likelihood loss; and
program code to model multi-object occlusions according to the negative log-likelihood loss.

15. The non-transitory computer-readable medium of claim 11, further comprising:
program code to apply score distillation sampling (SDS) to each object identified in the initial video frame to form the static 3D gaussian representations of each object identified in the initial video frame;
program code to compose the static 3D Gaussians for each object in a global space using depth-based initialization and optimization; and
program code to re-project error from an input video, along with individual object renders for score distillation.

16. The non-transitory computer-readable medium of claim 11, further comprising:
program code to decompose the 3D video scene into object tracks;
program code to optimize a differentiable and deformable set of the static 3D Gaussians for each of the object tracks;
program code to jointly splat the static 3D Gaussians for each of the object tracks to compute rendering errors in observed frames; and
program code to apply differentiable affine transformations to jointly optimize both global image re-projection and object-centric score distillation objectives within a unified framework.

17. A system for multi-object 4D scene generation, the system comprising:
an object isolation module to process a monocular multi-object video to isolate each object in a 3D video scene represented by an initial video frame of the monocular multi-object video;
a 3D gaussian generation module to generate a static 3D Gaussian representation for each object in the 3D scene;
3D scene composition module to compose the 3D scene, including the static 3D Gaussian representation of each object in the 3D scene, based on initial depth predictions of each object in the 3D video scene; and
4D scene generation module to jointly render and optimize deformations of the static 3D Gaussian representation of each object in the 3D video scene according to a rendering loss to form a multi-object 4D scene.

18. The system of claim 17, further comprising a planner to plan an object grasp by a robot of an object represented by the completed 3D shape.

19. The system of claim 17, in which the 3D scene composition module is further to apply score distillation sampling (SDS) to each object identified in the initial video frame to form the static 3D gaussian representations of each object identified in the initial video frame, to compose the static 3D Gaussians for each object in a global space using depth-based initialization and optimization, and program code to re-project error from an input video, along with individual object renders for score distillation.

20. The system of claim 17, in which the 4D scene generation module is further to decompose the 3D video scene into object tracks, to optimize a differentiable and deformable set of the static 3D Gaussians for each of the object tracks, to jointly splat the static 3D Gaussians for each of the object tracks to compute rendering errors in observed frames, and to apply differentiable affine transformations to jointly optimize both global image re-projection and object-centric score distillation objectives within a unified framework.
